(19) United States
(12) Patent Application Publication
(10) Pub. No.: US 2015/0075883 A1
(43) Pub. Date: Mar. 19, 2015

(54) Apparatus And Method Of Powering A Wheeled Vehicle

(71) Applicant: Anthony Ward, Langley (CA)

(72) Inventor: Anthony Ward, Langley (CA)

(21) Appl. No.: 14/490,664

(22) Filed: Sep. 18, 2014

(30) Foreign Application Priority Data
Sep. 19, 2013 (CA) 2827300

(51) Int. Cl. B62M 6/60; B23B 45/02; A63C 17/12

(52) U.S. Cl. CPC B62M 6/60; A63C 17/12; B23B 45/02
USPC 180/65.6; 180/65.1

(57) ABSTRACT

An apparatus is provided for powering a wheeled vehicle which includes a cordless powered tool with a rechargeable battery and a rotational chuck. The apparatus has a drive assembly with a first and a second end. The first end is secured to the rotational chuck. A connector is provided at the second end for connecting the drive system to at least one wheel of the wheeled vehicle such that upon activation of the cordless power tool, a rotational output from the chuck of the cordless power tool is imparted to the drive assembly which transfers the rotational output to the at least one wheel of the vehicle.

### FIELD OF INVENTION

The present invention relates to an apparatus and method of powering a wheeled vehicle.

### CROSS REFERENCE TO RELATED APPLICATIONS

None.

### GOVERNMENT SUPPORT

None.

### BACKGROUND

Skateboarding has long been a form of transportation, sport and entertainment. Young people as well adults enjoy skateboarding as a fun recreational experience. Skateboarding offers riders the benefit of standing while operating the steering mechanism simply by leaning by various degrees to one side or another thereby turning the board in the direction of the lean. Due to its simplicity, size, low cost, as well as positive emotional experience that the riders feel, the skateboard has not been a passing fad. It is here to stay. Additionally, skateboarding has experienced many variations along its history. Most recently long boarding has become very popular as riders have tapped into the benefits of a smoother and more comfortable ride offered by a longer deck, wider wheel spacing, and larger, softer wheels.

Traditionally, skateboards are propelled forward by foot. A rider balances on the board or deck of the skateboard with one foot, while kicking the skateboard forward with the other foot to propel the skateboard. The rider can rest briefly while the skateboard glides forward. Alternatively, the rider can place both feet on the deck of the skateboard, and allow the force of gravity to propel the skateboard down an inclined surface.

Powered skateboards have been developed which eliminate or reduce the step of kicking the skateboard forward or relying on inclined surfaces. Powered skateboards include those with gas engines or battery powered electric motors that are mounted on top of or beneath the deck of the skateboard. Such improvements are disclosed in U.S. Pat. No. 5,330,026 and U.S. Pat. No. 4,143,728. The powered skateboards are often controlled by handheld wireless remote controllers. As with a regular skateboard, powered skateboards are steered by a rider shifting his or her weight. The mounting of an engine or motor to a skateboard can often interfere with shifting motions necessary for steering the skateboard. Moreover, adaptations that are required to motorize a skateboard by mounting an engine to the deck tend to be permanent. As a result, most powered skateboards do not ride the same way as their unpowered counterparts. The decks are usually higher off the ground due to the necessity of attaching a battery or engine in a discrete location where it would not obstruct the feet of the rider. Also, powered skateboards are very much heavier, and the resulting ride is awkward rather than fluid. Lastly, due to the trade-off of regenerative breaking these boards typically do not coast and riders will feel a drag due to the effect of being under the power of the motor. Powered skateboards and scooters are also 2 to 5 times more expensive than a traditional skateboard due to the addition of a motor, electronics, and batteries as well as other increased engineering requirements.

Some vehicles such as scooters, have been disclosed as being powered by a power drill as disclosed in WO2001017844, however they require substantial modifications to the vehicle in order to mount the power drill to the scooter.

What is required is an apparatus and method of motorizing a skateboard which requires minimal modification and cost, and does not interfere with the operation and steering of the skateboard.

### SUMMARY

There is provided an apparatus for powering a wheeled vehicle which includes a cordless powered tool with a rechargeable battery and a rotational chuck. A drive assembly is provided with a first and a second end, the first end is secured to the rotational chuck. A connector is provided at the second end for connecting the drive system to at least one wheel of the wheeled vehicle such that upon activation of the cordless power tool, a rotational output from the chuck of the cordless power tool is imparted to the drive assembly which transfers the rotational output to the at least one wheel of the vehicle.

### BRIEF DESCRIPTION OF THE DRAWINGS

These and other features will become more apparent from the following description in which reference is made to the drawings, included for the purpose of illustration only and are not intended to be in any way limiting, wherein:

FIG. 1 is a side elevation view of an apparatus for powering a skateboard, shown in use on a skateboard;

FIG. 2 is a top plan view of the apparatus in FIG. 1 and a skateboard;

FIG. 3 is a detailed side view of bevel gears of the apparatus;

FIG. 4 is a transparent perspective view of a connection;

FIG. 5 is a front elevation view of the powered skateboard illustrated in FIG. 1;

FIG. 6 is an exploded detailed view of the freewheel assembly of the apparatus;

FIG. 7 is a side elevation view of the powered skateboard with a rider;

FIG. 8 is a side elevation view of first variation of the apparatus powering a skateboard;

FIG. 9 is a top plan view of a second variation of the apparatus in use with a skateboard;

FIG. 10 is a top plan view of a third variation the apparatus in use with a skateboard;

FIG. 11 is a perspective view of a fourth variation of the apparatus in use with a skateboard;

FIG. 12 is a top plan view of a fifth variation of the apparatus in use with a skateboard;

FIG. 13 is a side elevation view of the apparatus in use on a dolly cart;

FIG. 14 is a side elevation view of the apparatus in use on a boat;

FIG. 15 is a side elevation view of the apparatus in use on a shopping cart;

FIG. 16 is a front elevation view of the apparatus powering a skateboard with a rider;

FIG. 17 is a side elevation view of an apparatus attached to a skateboard;

FIG. 18 is a side elevation view of another apparatus attached to a skateboard;

FIG. 19 is a top elevation view of another apparatus attached to a skateboard;

FIG. 20 is a top elevation view of yet another apparatus attached to a skateboard; and

FIG. 21 is a side elevation view of the apparatus attached to a skateboard shown in FIG. 20.

### DETAILED DESCRIPTION

An apparatus and method of powering a wheeled vehicle will now be described with reference to the drawings.

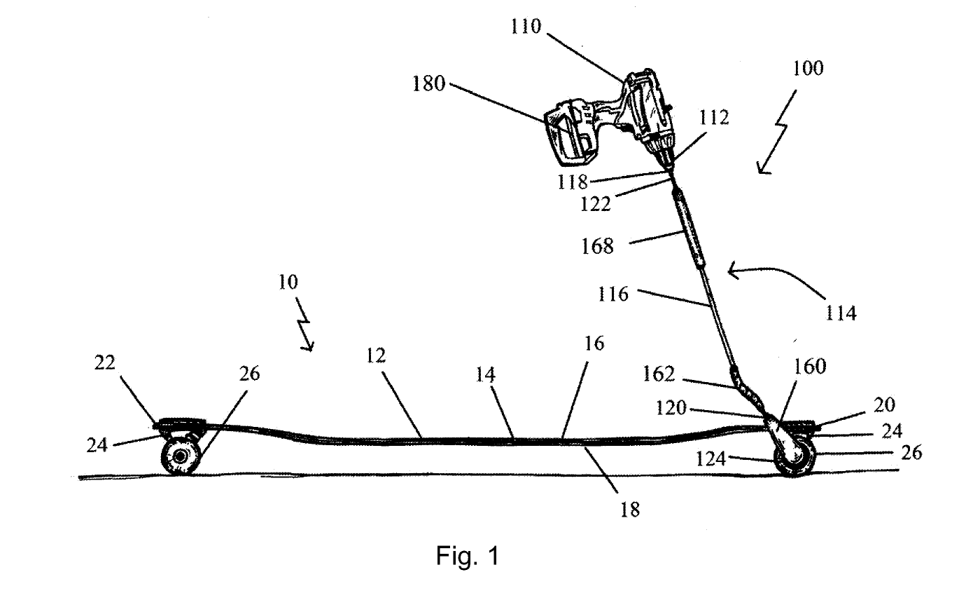

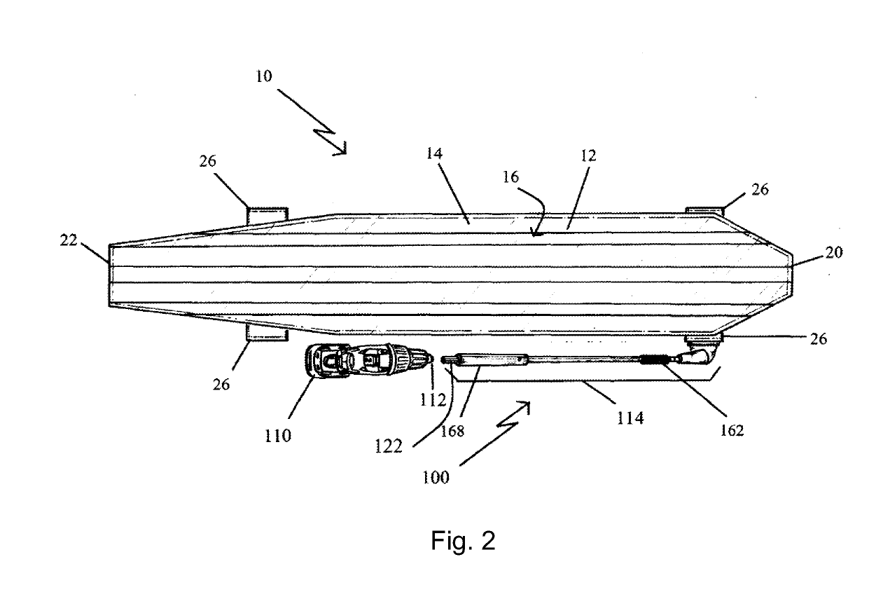

Referring to FIG. 1, there is illustrated vehicle 10 in the form of a skateboard 12 with a deck 14 which has an upper side 16 and a lower side 18. Referring to FIG. 2, the deck 14 is elongate with a first end 20 and a second end 22. Referring again to FIG. 1, two trucks 24 are mounted to the lower side 18 toward the first end 20 and toward the second end 22. Each truck 24 is provided with two opposed rotatable wheels 26.

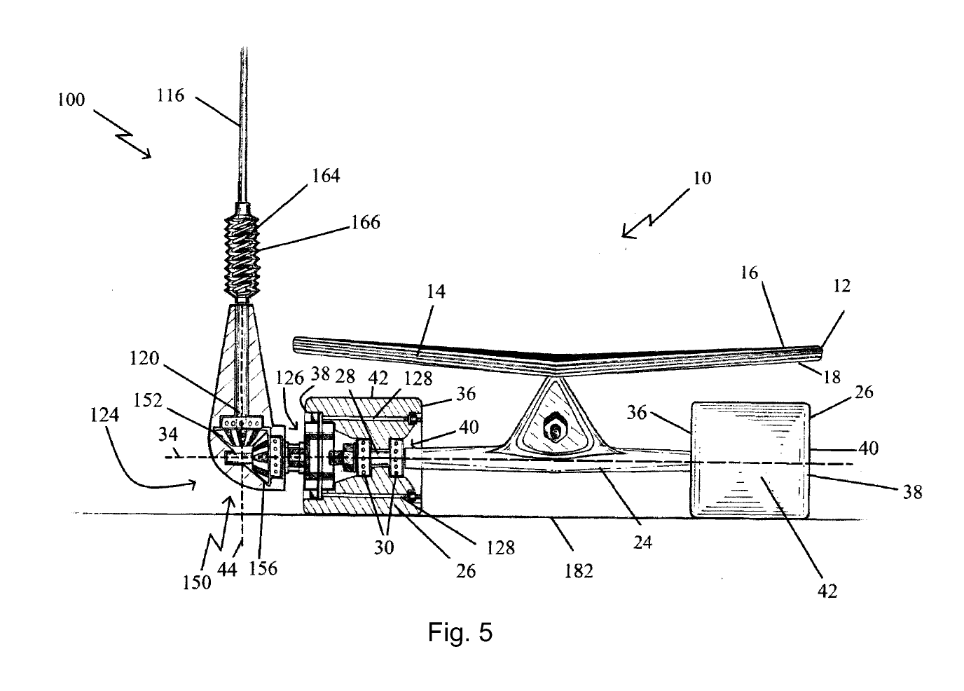

Referring to FIG. 5, an axle 28 extends through the truck 24. Referring to FIG. 1, trucks 24 connect the wheels 26 to the deck 14. Referring to FIG. 1 and FIG. 5, each of the wheels 26 is mounted on the axle 28 via bearings 30. Wheels 26 rotate around a rotational axis 34 that is defined by the axle 28. Each wheel 26 has an inside edge 36, and outside edge 38, and a road engaging surface 42.

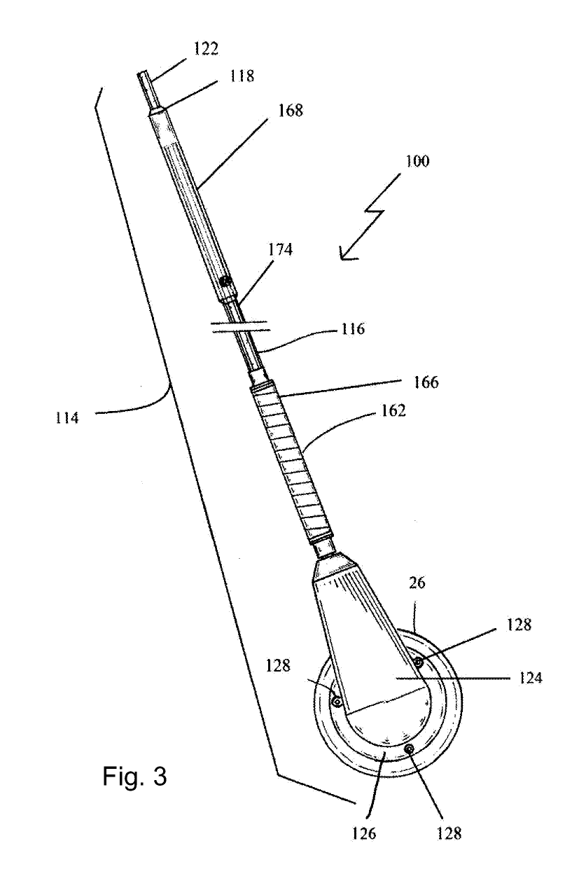

Referring to FIG. 1, there is illustrated the apparatus 100 includes a cordless powered tool such as a cordless electric drill 110 with a rotating chuck 112. Referring to FIG. 2, a drive assembly generally referenced by numeral 114 is shown. Drive assembly 114 includes an elongate drive shaft 116 which has a first end 118 and a second end 120. Referring to FIG. 3, a connector 122 is provided at the first end 118 of the drive shaft 116 which fits securely within the rotating chuck 112 of the cordless power tool 110 as illustrated in FIG. 1. Referring to FIG. 5, a drive gear 124 is provided at the second end 120 of the drive shaft 116. A freewheel assembly 126 is secured to the front right wheel 26 of the skateboard 12 by bolts 128. It will be appreciated that it could also be secured to the left front wheel 26 or any of the other wheels 26 as desired.

In FIG. 2 the cordless power drill 110 is shown spaced apart from the drive assembly 114. It is to be understood that the cordless power drill 110 can connect to any normal hexagon, square, or round “drill bit style” end.

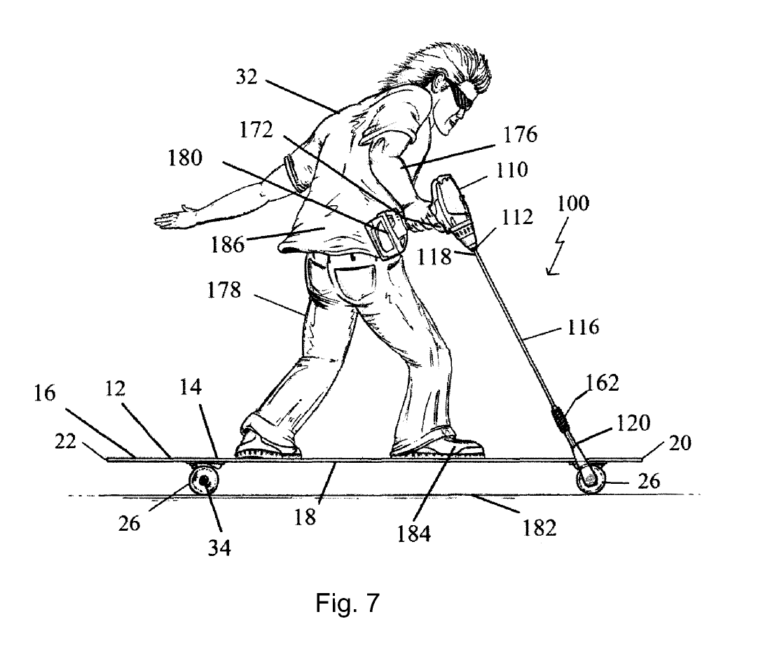

Upon activation of the cordless power tool 110 by a rider 32 as illustrated in FIG. 7, a rotational output is imparted to the elongated drive shaft 116 of the drive assembly 114 which rotates the drive gear 124 and transfers the rotational movement to the freewheel assembly 126 to drive the front wheel 26 of the skateboard 12. As a result the skateboard 12 is propelled forward.

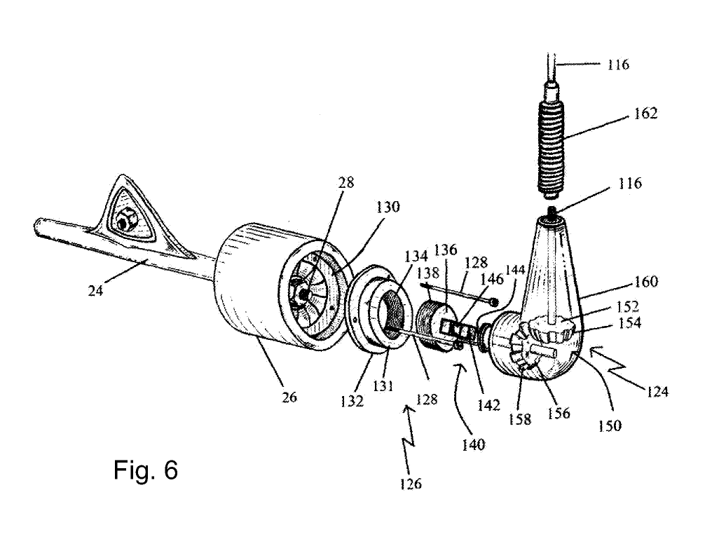

Referring to FIG. 6, the freewheel assembly 126 is secured to the front wheel 26 of the skateboard 12 which has a machined bore hole 130 to receive the freewheel assembly 126. Although illustrated as being secured one of the front wheels 26, it will be appreciated that the freewheel assembly 126 could be attached to any of the wheels 26. Bolts 128 are used to secure the freewheel assembly 126 to the front wheel 26. Freewheel assembly 126 includes a freewheel clutch 131 with flange mounting plate 132 with a threaded receiving aperture 134 and a hub 136 with threads 138 that mate within the threaded receiving aperture 134. The freewheel clutch 131 or sprag clutch permits one direction movement known as freewheeling or coasting and engages to lock motion in the other direction whereby torque is transferred from the drive assembly 114 through the freewheel assembly 126 to the drive wheel 26.

Referring again to FIG. 6 again, there is provided a quick connect feature general referenced by number 140. The quick connect feature 140 includes a square post 142 that extends from hub 136. The square post 142 is received in a square shaped receptacle 144 on the drive gear 124 and has a projection 146 which allows it to remain locked and engaged within the square shaped receptacle 144. The projection 146 can be overcome with manual force to disengage the drive assembly 114 from the free wheel assembly 126. The quick connect feature 140 allows the drive assembly 114 to be quickly attached to or detached from the freewheel assembly 126 on the front wheel 26 of the skateboard 12 as desired. It will be appreciated that there are other types of quick connect features and drive post shapes and configurations including the reversal of the male and female connections which will accomplish the same effect. Furthermore, a permanent mounting system could be used instead of a quick connection.

Referring to FIG. 6, in the illustrated embodiment, the drive gear 124 includes a bevel gear arrangement 150 that has a first bevel gear 152 with a first gear profile 154 and a second bevel gear 156 with a second profile 158. The first gear profile 154 and the second gear profile 158 are configured to engage with each other. First bevel gear 152 is provided on the drive shaft 116. Referring to FIG. 5, the second bevel gear 156 is perpendicular to the first bevel gear 152 such that the first gear profile 154 engages with the second gear profile 158 as illustrated in FIG. 6, such that upon activation, the bevel gear arrangement 150 transfers the primarily vertical or semi-vertical spinning position from the drive shaft 116 to a horizontal spinning motion required to turn the front wheel 26. A protective cover 160 overlies the bevel gear arrangement 150.

Referring to FIG. 6, the skateboard wheels 26 can be custom machined or moulded such that the freewheel assembly 126 is uniquely mated to the skateboard wheel 26. Alternatively, the freewheel assembly 126 could be moulded to the outer side 38 of the wheel 26. It will be appreciated that the freewheel assembly 126 can be permanently or detachably secured to the wheel 26 of the skateboard 12 by use of bolts 128, screws, or other fastener or fastening system not described here. As discussed above, it will also be appreciated that there are other types of quick connect methods that can be used instead of the one described.

Referring to FIG. 3, the elongated drive shaft 116 can incorporate a flexible section generally referenced by numeral 162 which is positioned toward the bevel gear and utilizes a spring 164 and has a covering sleeve 166. The flexible section 162 allows the drive shaft 116 to flex or move relative to the bevel gear arrangement 150 but still transfer the rotational output. It will be appreciated that there are other configurations and methods of providing a flexible section 162 on the drive shaft 116. In the illustrated embodiment, the flexible section is a spring 164 which allows flexibility but still transmits the rotational output. Flexible section 162 can be covered by a flexible protective sleeve 166. Common flexible shafts utilize tightly wound wires in the form of a cable.

Referring to FIG. 2 and FIG. 3, the drive shaft 116 also includes a telescopically adjustable portion 168 such that the drive shaft 116 can be lengthened or shortened as desired depending on the preference of the rider 32 as illustrated in FIG. 7. Telescopically adjustable portion 168 also permits the drive shaft 116 to be shortened for ease of transportation or storage when the apparatus 100 is not in use. It will be appreciated that there are other methods that are known which can be incorporated to allow for the drive shaft 116 to be adjusted in length.

The use and operation of embodiments of the invention for powering a vehicle wheel will now be described with reference to the drawings.

Referring to FIG. 7, there is illustrated a rider 32 balancing on the upper side of the deck of the skateboard 12. In his right hand 70, the rider 32 holds the gripping handle 172 of the electric drill 110. The rider 32 can activate of the electric drill by finger squeezing the handle 172 which depresses a power button (not shown). Upon activation, the cordless electric drill 110 produces a rotational output though the rotating chuck 112.

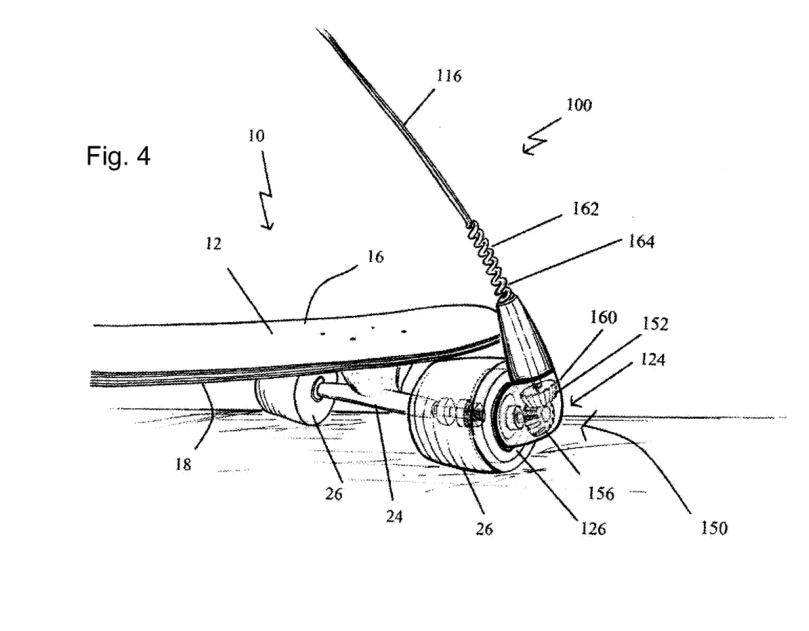

Referring to FIG. 4 and FIG. 5, the rotational output is then imparted to drive assembly 114 along the elongated drive shaft 116 which then causes the first bevel gear 152 of the bevel gear arrangement 150 to rotate the second bevel gear 156. The direction turning movement of the bevel gear arrangement 150 transfers to the wheel 26 as second bevel gear 156 is connected to the quick connect feature 140 to the freewheel assembly 126 to the wheel 26 which then spins on the axel 28 of the truck 24. This allows the transfer of the rotational movement from the drive shaft 116 to the freewheel assembly 126 to drive the front wheel 26 of the skateboard 12.

Referring again to FIG. 7, as a result the skateboard 12 along with the rider 32 is propelled forward. Forward propulsion ceases when the rider 32 releases the finger squeeze on the trigger 172 of the electric drill 110. The rider and board then coasts while decelerating slowly due to internal wheel bearing resistance, freewheel sprag resistance, wheel to road resistance, and wind resistance. The freewheel assembly 126 allows the rider 32 to simply coast on level ground 182 as well as to glide downhill. Furthermore, the freewheel permits the conventional use of foot 184 pushing to propel the skateboard 12 forward.

Referring to FIG. 5 and FIG. 7, the inclusion of the freewheel assembly 126 permits the skateboard 26 to roll forward easily and fluidly even though power is not being applied to the wheel 26 from the electric drill 110. This allows the rider 32 to ‘coast’ without the drive assembly's 114 engagement or to switch to foot pushing as desired.

Referring to FIG. 5, the freewheel 126 is attached to a direction changing drive gear 124 such as a bevel gear arrangement 150 as illustrated or a flex drive by a quick connect feature 140. The bevel gear arrangement 150 or similar direction changing gear 124 allows the drive of the wheel 26 to be converted from a primarily vertical or semi-vertical spinning motion along the rotational axis 44 defined by the drive shaft 116 to a primarily horizontal or semi-horizontal spinning motion along the rotational axis 34 of the wheel 26.

Referring to FIG. 6, the freewheel assembly 126 may be secured to the front wheel 26 of the skateboard 12 which has a machined bore hole 130 to receive the freewheel assembly 126.

Referring to FIG. 4 and FIG. 7, as described above, the elongated drive shaft 116 can incorporate a flexible section 162 which utilizes spring 164 although it will be appreciated that other types of spring type attachments, universal joints, or flex drive attachments can be used in order to allow the rider 32 to adjust the angle of the apparatus 100 for a more comfortable riding experience by permitting the rider to lean his or her body 186 into or away from a curve without an uncomfortable or awkward posture. The flexible section 162 also allows the apparatus 100 to absorb some of the necessary movement that is incurred during the process of riding the skateboard 12. Due to the fact that the apparatus 100 is attached to the outside 36 of the wheel 26 off of the freewheel assembly 126, the rider 32 can pivot the shaft in varying degrees from the centre 38 of the wheel 26 in a clockwise and counter clockwise direction in line with the rotational axis 34 of the wheel 26 illustrated in FIG. 5. It will be appreciated that although a flexible section 162 offers the rider 32 a more comfortable riding experience, apparatus 100 could also be provided without this section.

Referring to FIG. 1, and FIG. 7, the drive shaft 116 is shown with a telescopically adjustable portion 168 however there are various known methods of lengthening or providing adjustable shaft extensions which enable the rider 32 to adjust the drive shaft 116 to a comfortable length according to his or her height and riding position. Referring to FIG. 3 and FIG. 7, the drive shaft 116 may or may not have a shaft guard or protective sleeve 174 which protects riders 32 from the rotating drive shaft 116 should he or she come in contact with it. A shaft guard 174 would also help to prevent anything from wrapping around the drive shaft 116 and interfering with its operation.

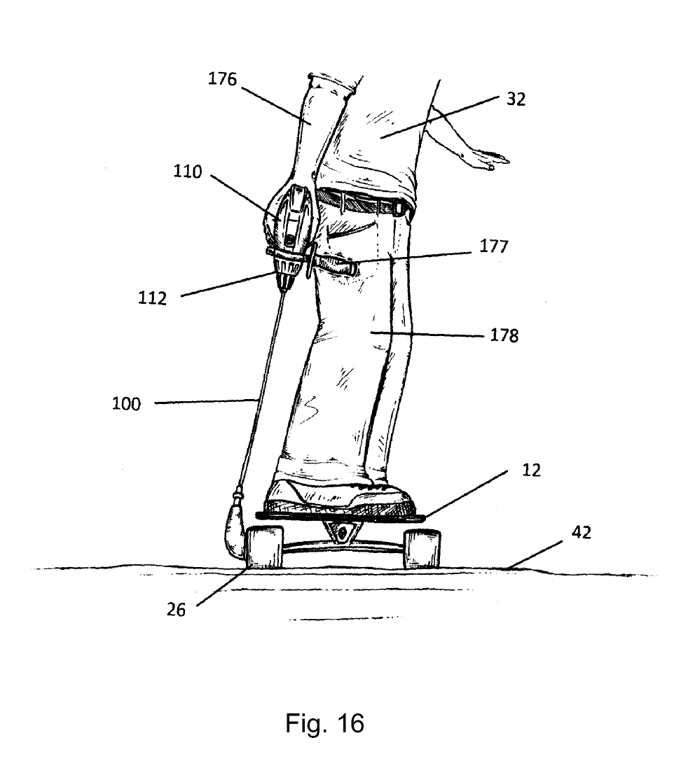

Referring to FIG. 16 in order to help to minimize the effects of torque from potentially exhausting the rider's 32 arm 176, riders 32 could rest an auxiliary handle 177 if provided with the selected electric drill 110 which is usually attached behind the chuck 112 of the electric drill 110 against their leg 178. It will be appreciated that not all cordless drills 110 come with auxiliary handles.

Referring to FIG. 1 through FIG. 7, with the apparatus 100 and method described above, many of the less desirable elements of powering a skateboard are eliminated As the rider 32 is carrying the power drill 110 comfortably in their hand 170 there is no need to elevate the deck 14 of the skateboard 12 to mount a battery. Rather the rechargeable battery 180 is carried by the electric drill 110. Therefore the skateboard 12 can be ridden at a normal height which is preferably low to the ground. This helps to keep the centre of gravity lower and allows for better response and steering ability by the rider 32. This apparatus 100 and method allows for the rider 32 to experience normal skateboarding movements such as steering and alternating between foot pushing and powered use while riding.

Referring to FIG. 7, the use of the power drill 110 allows the rider 32 to control the propulsion of the skateboard 12 by delivering power to the wheel 26 through a familiar and comfortable finger squeeze trigger. As this finger squeeze mechanism is familiar, the rider 32 is able to quickly and intuitively understand the function of power delivery and forward movement without altering an individual's muscle memory for skateboard riding which foot pedal type devices would.

Referring to FIG. 6, a further benefit is that the apparatus 100 may be removed and reattached to the skateboard 12 with the quick connect feature 140 which can be used for quickly and simply attaching the wheel 26 of the skateboard 12 to the freewheel assembly 126. Upon detaching the apparatus 100, the skateboard 12 may be used as a regular skateboard 12. Referring again to FIG. 7, when desired, the apparatus 100 can be attached to the wheel 26 of the skateboard 12 to allow the rider 32 to not have to propel the board using his or her legs 178 to push the skateboard 12 forward. Accordingly, the apparatus 100 allows for any skateboard 12 to be converted to a motorized skateboard 12 with the simple addition of the apparatus 100.

Although this device could be used on any size of skateboard 12, the most obvious use would be for longboard skateboards which more commonly use larger diameter wheels 26. A preferred wheel size of greater than 65 mm is considered ideal.

Referring to FIG. 7, with the apparatus 100 and method described above the rider 32 can use his or her own skateboard 12 without substantial adaptations, and without having to buy a whole new board 12. It will be noted that many of the present electric skateboards are whole units sold together with a motor already installed. With most prior art electric skateboards, the battery packs or power supply is attached to the bottom of the skateboard deck. This means that most electric skateboards have to have higher deck heights which result in a less stable ride. This is not seen as desirable as most standard skateboards 12 tend toward lower deck designs to permit the rider 32 to maintain a lower centre of gravity which facilitates safer cornering.

Referring again to FIG. 7, in the present invention, the apparatus 100 allows a rider 32 to use to power their own skateboard with a type of power source which most home owner currently have: a rechargeable electric drill 110. If the rider 32 wishes to have more power he or she can upgrade to a professional power drill in order to deliver better performance with respect to speed, torque, and distance. Riders 32 may use the most efficient high technology batteries and brushless motors which are not always typically employed for electric skateboards. While an electric power drill 110 is illustrated is will be appreciated that any handheld power tool with the ability to provide a sufficient rotation output can be used in conjunction with the drive assembly 114.

Referring again to FIG. 1, many people already own a power tool such as a cordless power drill 110 so there may be no need for them to buy one. The cordless power drill 110 can be a professional grade higher output power drill with longer lasting lithium ion batteries or an inexpensive homeowner type power drill 100 with nickel cadmium batteries. It will be appreciated that the style, brand or type that is used is up to the preference of the user. Impact drills would not be suitable due to the foreseeable damage they might cause on gears. For the same reason drills with ‘hammer’ settings would need to have that setting switched off. Also, the rider 32 may select a power drill 110 which has a battery or batteries with greater amp hour capacity to allow for longer rides. Since the apparatus 100 can accommodate a wide variety of power tools such as electric drills, the costs can be higher or lower depending on the power tool selected. If the power tool 110 needs replacement, it can be easily obtained from almost any tool or hardware store. Moreover many cordless drills come with extra batteries which also can be purchased separately and charged for those who require extra distance.

Due to the fact that cordless power drills 110 have sold millions in the last 20 years there is a lot of competition in the market place whereby in order to maintain or increase their market share companies are driven to spend a lot of money in product research and development. This funding greatly exceeds the limited resources available from the much smaller market of electric skateboard manufacturers. Therefore, power tool manufacturers continue to have superior motors, battery technology, and electronics.

The quick connect feature 140 illustrated in FIG. 6 allows apparatus 100 to be removed from the wheel 26 in a few seconds thereby allowing the skateboard 12 to operate in an identical manner to any regular skateboard 12 with the same configuration of wheels 26, trucks 24, deck 14 and bearings 30 etc.

It will be appreciated that the illustrated embodiment features the drive gear 124 at the second end of 120 of the drive shaft 116, although transmission of the rotational output may be altered to incorporate a bevel gear arrangement 150 at the first end 118 of the drive shaft 116 adjacent the electric drill 110 of the apparatus 100 utilizing a chain, belt, cable, string, or cord to drive the freewheel assembly 126 attached to the wheel 26. Using the above mentioned transmission, the wheel 26 could be driven from either the inside 36 or outside 38 of the wheel 26 as illustrated.

Though there are many benefits to the apparatus 100 and method described above, it is important to note that the torque produced by the motor of the electric drill 110 requires a certain amount of the rider's 32 forearm 176 muscle control to overcome depending on the amount of torque produced by the drill 110, the weight of the rider 32, and the degree of slope of the underlying surface 182 on which that he or she is traversing.

The drive wheel 26 may tend to want to spin without gaining traction until the rider 32 first learns to center his or her weight over the skateboard 12 and smoothly squeeze activate the electric drill 110 allowing for a gradual increase of torque and speed.

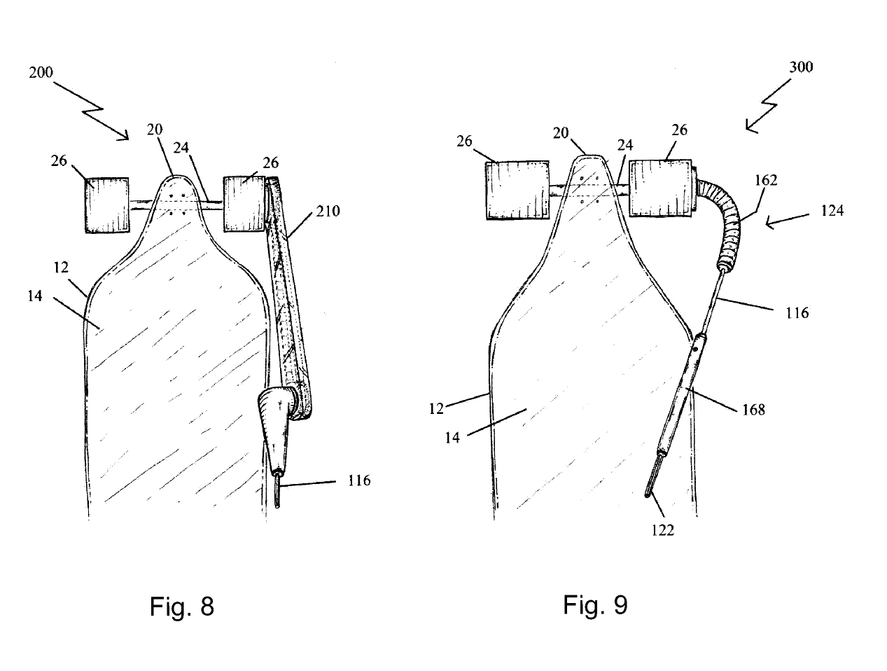

Referring to FIG. 8, there is illustrated a first variation of the apparatus powering a skateboard generally referenced by numeral 200. With first variation, a belt, chain, cable or cord drive arrangement 210 is disposed between the freewheel assembly 126 and the bevel gear arrangement 150. This configuration allows for a narrower total width when attached to the skateboard which may make the attachment less prone to being clipped by an obstacle like a road curb or sign post. Furthermore, element 210 may be a short section extending just past the wheel and then attached to the bevel gear whereby drive shaft 116 is the longer portion extending the greater distance to connect to the power drill. Alternatively, element 210 may be the longer section whereby the shaft 116 is just long enough to attach into the rotating chuck 112.

Referring to FIG. 9 is illustrated a second variation of the apparatus in use with a skateboard generally referenced by numeral 300. With second variation 300, the flexible section 162 of the drive shaft 116 also functions as the direction changing drive gear 124. The bevel gear arrangement 150 is no longer needed as the flexible section 162 connects directly to the free wheel assembly 126 to transfer the rotational output to the wheel 26 of the skateboard 12.

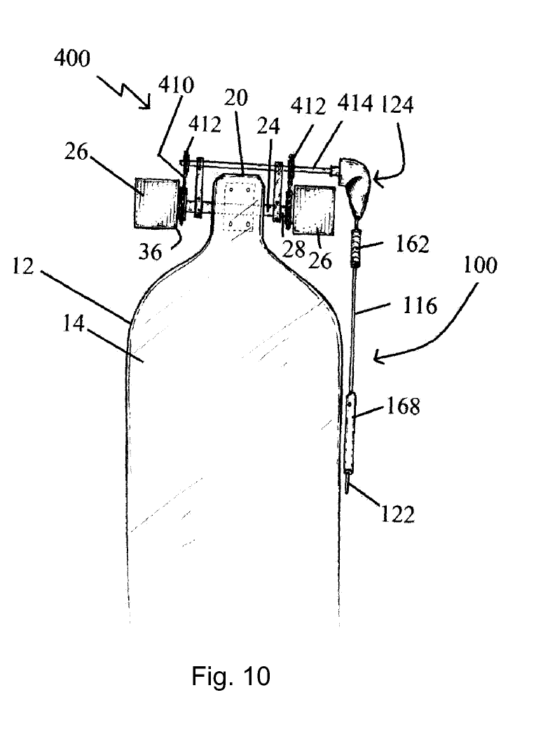

Referring to FIG. 10 there is illustrated a third variation the apparatus in use with a skateboard generally referenced by numeral 400. Third variation 400 incorporates attaching the bevel gear arrangement 150 of apparatus 100 whereby power is delivered to second axel 414 connected to two sprocket gears 412 transferring power to belt or chain 410 to two freewheel spockets mounted on the inside edges 36 of the two wheels 26 on the same front or rear truck. This variation transfers torque to two wheels 26 instead of just one like other variations whereby greater traction is gained by the use of two drive wheels.

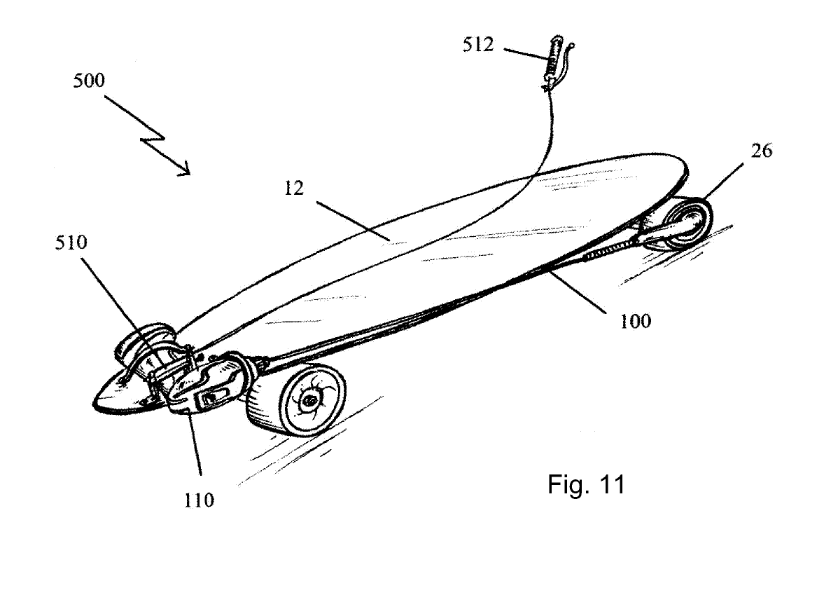

FIG. 11 is a forth variation of the apparatus in use with a skateboard generally referenced by numeral 500. With variation 500, it is envisioned that the electric drill 110 may be attached to a non-rolling portion of the skateboard 12 such as the deck 14 or the trucks 24. In the illustrated embodiment, brackets 510 are used to secure the electric drill 110 in place, however there are other means known in the art for securing the electric drill in position. It is envisioned that with this type of attachment there would be required a throttle attachment 512 to activate the electric drill 110.

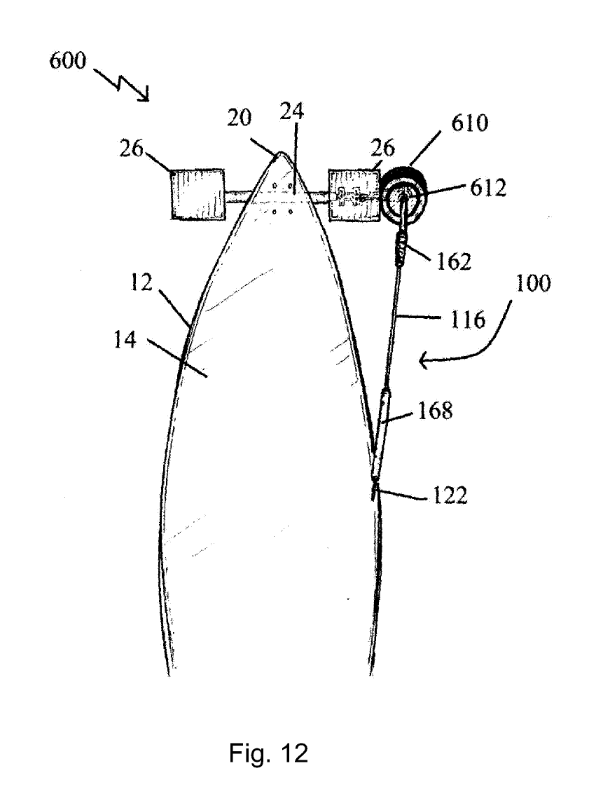

Referring to FIG. 12 there is illustrated a fifth variation of the apparatus in use with a skateboard generally reference by numeral 600. In fifth variation 600, the drive gear is a drive wheel 610 with an internal freewheel 612. Drive wheel 610 engages wheel 26 to impart rotational output from drive shaft 116.

Although not illustrated, as an alternative to the quick connect feature 140 illustrated in FIG. 6, apparatus 100 can be provided with a wheel 26 which can be used to replace one or more of the original wheels 26 on the skateboard 12 as the freewheel assembly 126 has a minimum size whereby wheels of a minimum diameter are required. Apparatus 100 would then be more permanently installed on the skateboard 12. It is likely that Apparatus 100 would include four machined or moulded wheels 26 with bore hole 130 uniquely suited to mate with freewheel assembly 126. Due to the fact that the drive wheel will normally wear down quicker than the three other skateboard wheels, by having all wheels moulded or machined in this fashion a rider could easily rotate the wheels on his or her board in order to maintain even wearing.

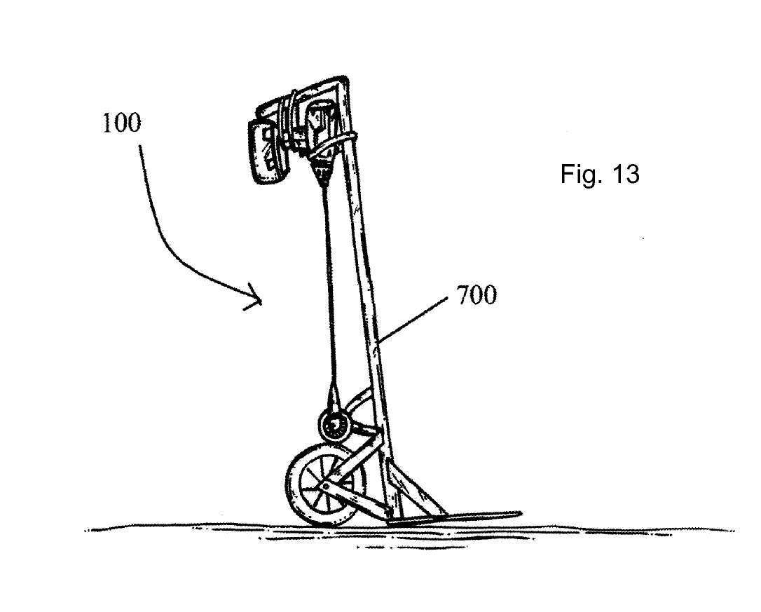

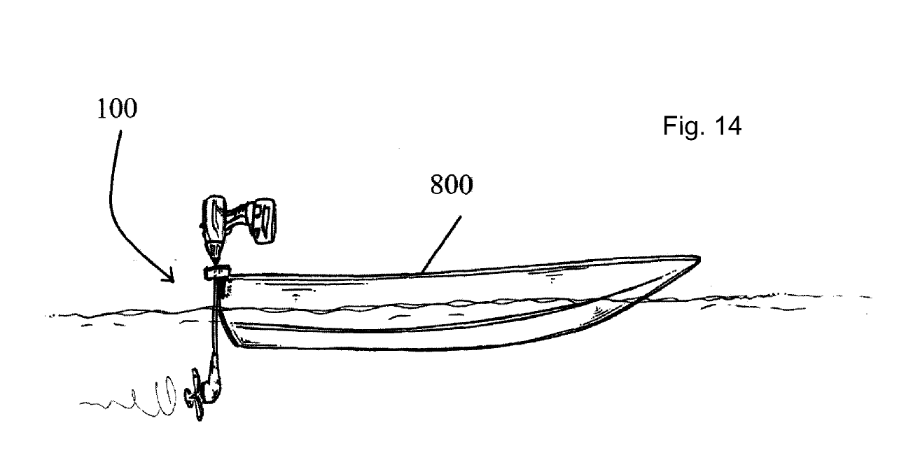

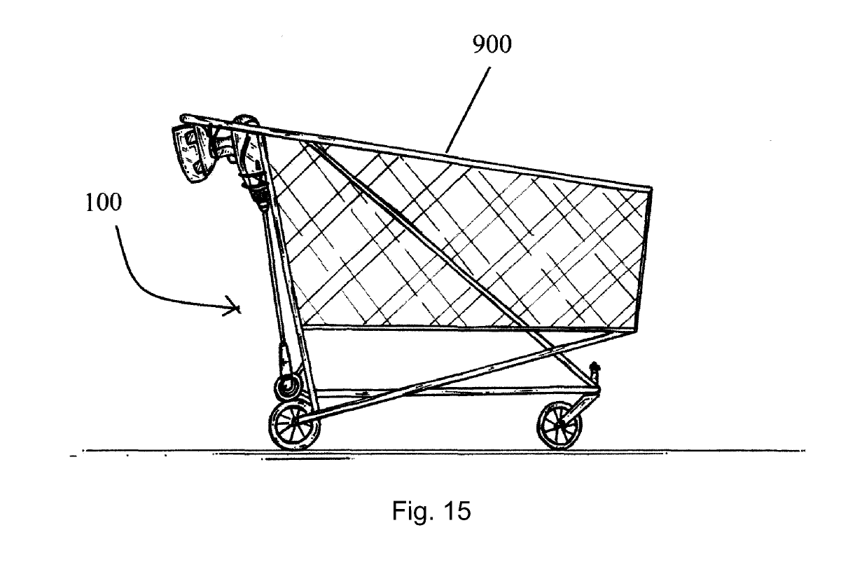

In addition, while the apparatus 100 and method are described as being used in association with skateboards 12, it could be used to power various other types of non-skateboarding transportation devices including a cargo dolly 700 as illustrated in FIG. 13, a boat 800 as illustrated in FIG. 14 and a shopping cart 900 as illustrated in FIG. 15. Although not illustrated apparatus and method 100 could also be used on a variety of other wheeled vehicles including but not limited to: strollers, scooters, carts, wheel barrows, inline skates, as well as small watercraft like kayaks, canoes, belly boats, and float tubes. It will be appreciated that the apparatus 100 will work on other types of wheels 26 that are used for other applications since it can be attached to the outer side 38 of the wheel 26.

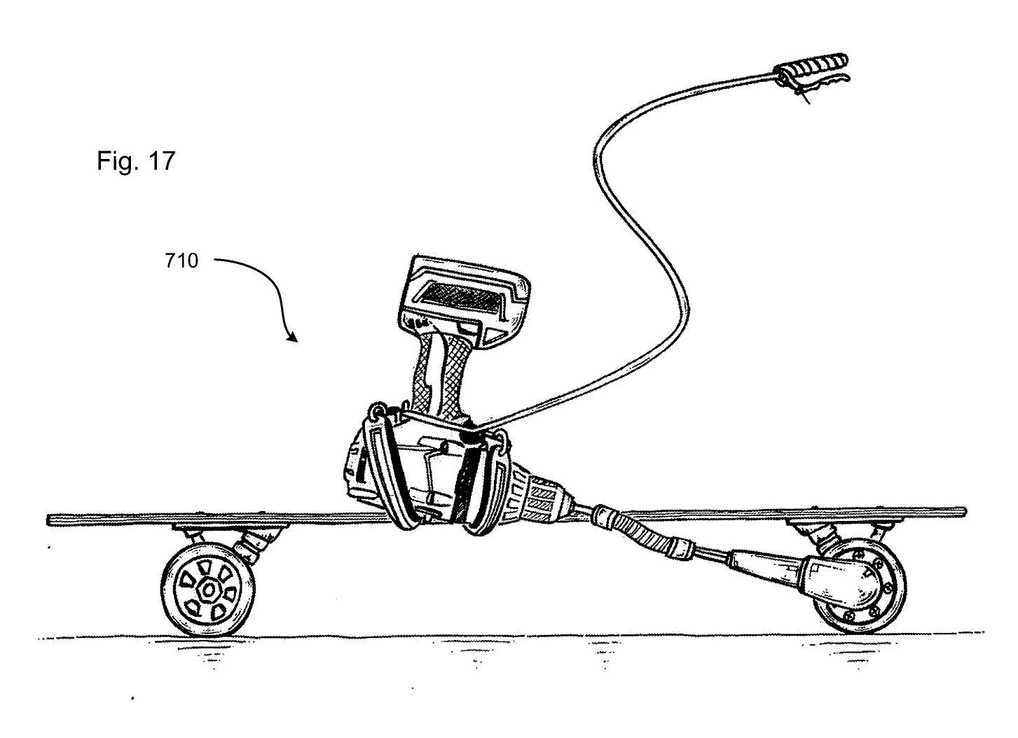

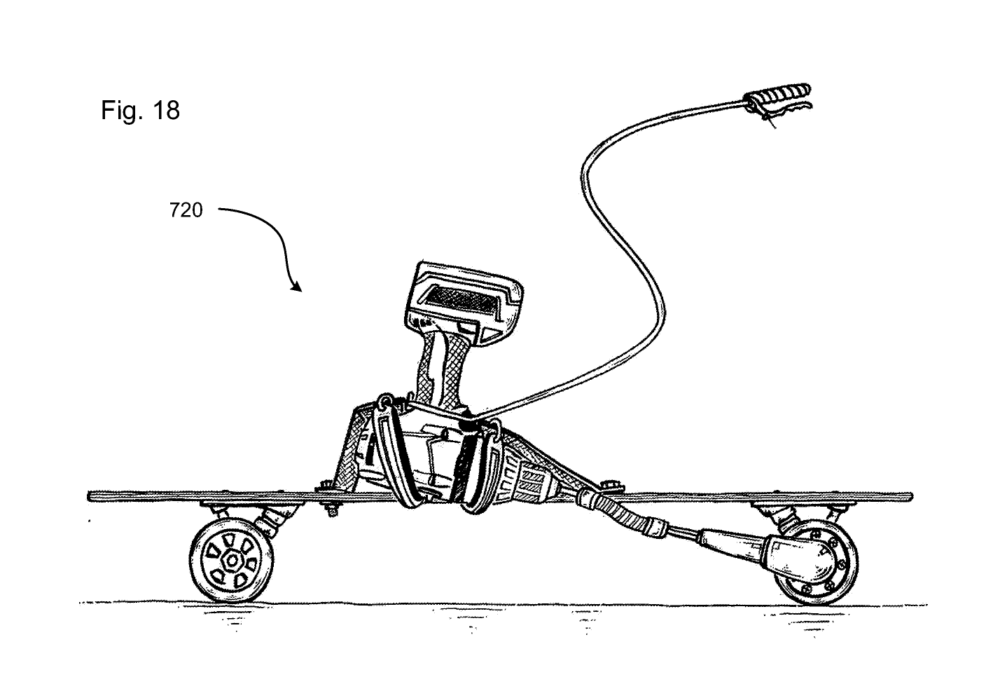

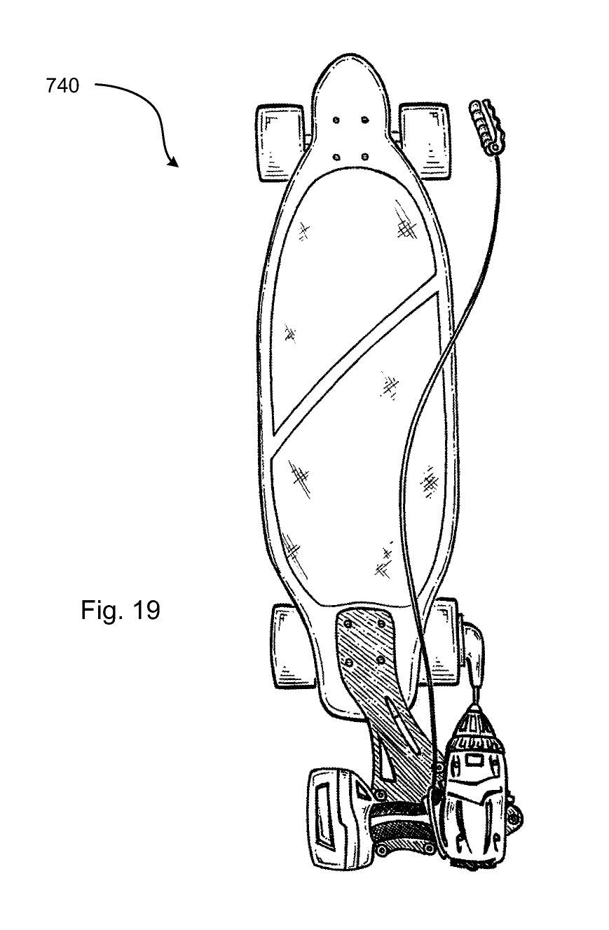

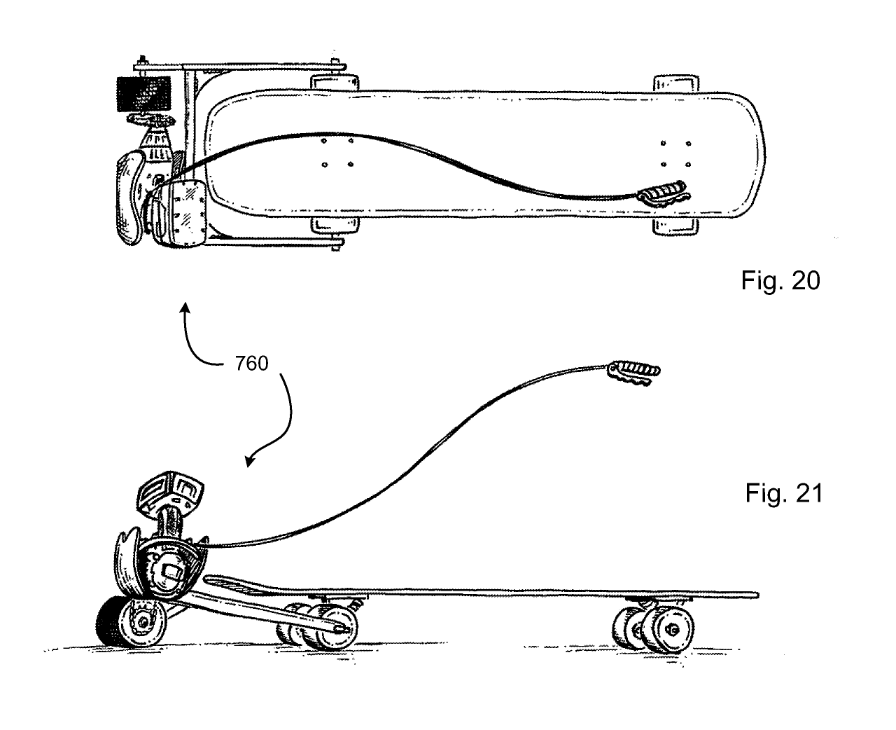

Referring to FIGS. 17-21, various embodiments are shown to attach a cordless power tool to a skateboard. In FIG. 17, embodiment 710 is attached to a skateboard without a bracket. In FIG. 18, embodiment 720 is attached to a skateboard with a bracket. In FIG. 19, embodiment 740 is attached to an added deck on the rear of the skateboard. In FIGS. 20 and 21 embodiment 760 is attached to a rear truck having a wheel and holding apparatus, which in turn is attached to a rear wheel of the skateboard. A bungee and/or harness and/or cradle can be used to attach a drill to the skateboard deck. As shown in embodiment 720 bungees can be attached to a bracket which is attached to the board.

In embodiments 710, 720, 740 and 760, a cable throttle is attached whereby the rider would squeeze a the hand held lever which would tighten a loop wrapped around the handle of the drill and across the finger ‘trigger’ of the drill, which in turn would cause the drill motor to be activated.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. An apparatus for powering a wheeled vehicle comprising;
a cordless powered tool having a rechargeable battery and a rotational chuck,
a drive assembly having a first and a second end,
a first connector connected to said first end and configured for detachably securing to the rotational chuck,
a second connector connected to said second end and configured for securing said drive assembly to at least one wheel of the wheeled vehicle such that upon activation of the cordless power tool, a rotational output from the chuck of the cordless power tool is imparted to said drive assembly, whereby a rotational output of said cordless power tool is transferred to said at least one wheel of the vehicle.

2. The apparatus of claim 1 wherein said drive assembly having an elongated drive shaft with a first shaft end and a second shaft end, a drive gear connected to said second shaft end, said drive gear having a rotatable output shaft that transfers rotational output to the at least one wheel.

3. The apparatus of claim 2 wherein said drive gear comprises a bevel gear.

4. The apparatus of claim 2 wherein said drive gear comprises a belt drive.

5. The apparatus of claim 2 wherein said drive gear comprises a chain drive.

6. The apparatus of claim 2 wherein said drive gear includes one or more of a flex drive and a universal joint.

7. The apparatus of claim 2 wherein said elongated drive shaft includes a section that that is telescopically extendable.

8. The apparatus of claim 2 wherein said elongated drive shaft includes a section adjacent to the second shaft end that is flexible.

9. The apparatus of claim 4 wherein said flexible section is one of a spring, universal joint, or flex drive attachment.

10. The apparatus of claim 1 wherein said drive assembly includes a freewheel assembly disposed between the one wheel and the drive gear.

11. The apparatus of claim 1 wherein said wheeled vehicle is one of a skateboard, scooter, inline skate, shopping cart, or wagon.

12. An apparatus for powering a wheeled vehicle comprising;
a cordless powered tool having a rechargeable battery and a rotational chuck,
a drive assembly having a first and a second end,
a first connector connected to said first end and configured for detachably securing to the rotational chuck,
a second connector connected to said second end and configured for securing said drive assembly to at least one wheel of the wheeled vehicle such that upon activation of the cordless power tool, a rotational output from the chuck of the cordless power tool is imparted to said drive assembly, whereby a rotational output of said cordless power tool is transferred to said at least one wheel of the vehicle;
said drive assembly having an elongated drive shaft with a first shaft end and a second shaft end, a drive gear connected to said second shaft end, said drive gear having a rotatable output shaft that transfers rotational output to the at least one wheel;
said drive gear having a bevel gear for transferring rotational movement to a freewheel assembly, said freewheel assembly disposed between said at least one wheel and said drive gear;
said elongated drive shaft having a section that that is telescopically extendable;
said elongated drive shaft includes a section adjacent to the second shaft end that is flexible; and
said flexible section being a flexible shaft.

13. The apparatus of claim 12 wherein said wheeled vehicle is a skateboard.

14. A method of powering a vehicle comprising:
activating a cordless tool powered by rechargeable battery, thereby activating a rotational chuck on said cordless power tool;
said activation of said rotational chuck activating a drive assembly having a first and a second end;
said activating said drive assembly activating a bevel gear assembly at said second end;
said activating said drive assembly activating a freewheel assembly is secured to said bevel gear assembly; and
said freewheel assembly causing a rotatable wheel of the vehicle to rotate.

15. The method of claim 14 wherein activation of said cordless tool imparts a rotational output to the elongated drive shaft which rotates the bevel gears and transfers rotational movement to said freewheel to drive the wheel causing the vehicle to move forward.

16. The method of claim 14 further comprising causing the wheeled vehicle to move forward wherein the wheeled vehicle is a skateboard.

17. The method of claim 14 further comprising causing the wheeled vehicle to move forward wherein the wheeled vehicle is a scooter.

18. The method of claim 14 further comprising causing the wheeled vehicle to move forward wherein the wheeled vehicle is an inline skate.

19. The method of claim 14 further comprising causing the wheeled vehicle to move forward wherein the wheeled vehicle is a shopping cart.

20. The method of claim 14 further comprising causing the wheeled vehicle to move forward wherein the wheeled vehicle is a wagon.
